(19) United States
(12) Patent Application Publication
(10) Pub. No.: US 2017/0050320 A1
(43) Pub. Date: Feb. 23, 2017

(54) NOVEL ROBOTIC DEVICE WITH A CONFIGURABLE BEHAVIOR IMAGE

(71) Applicant: Behzad Nejat, Cupertino, CA (US)

(72) Inventor: Behzad Nejat, Cupertino, CA (US)

(21) Appl. No.: 14/828,521

(22) Filed: Aug. 18, 2015

(51) Int. Cl. B25J 11/00; B25J 9/16

(52) U.S. Cl. CPC B25J 11/0005; B25J 9/163

(57) ABSTRACT

A system described herein pertains to robotic devices, and in particular to robotic devices with a unique output profile. A system consistent with the present disclosure includes an apparatus which includes a set of input devices, a set of output devices, and a memory unit. The memory unit includes a behavior image which dictates the manner in which the at least one output device operates. Upon receiving data through at least one of the input devices over a first time period reconfigures the behavior image.

A system described herein pertains to robotic devices, and in particular to robotic devices with a unique output profile.

### BACKGROUND

The field of robotics has advanced tremendously in the last few decades due to the power of computing. Many robotic devices are programmed to perform various tasks to reduce the need of human labor. In addition, robotic devices have been developed for personal entertainment. However, conventional robotic devices function exactly as they are programmed.

There exists a need for robotic devices to have their own uniqueness and individuality. The present disclosure addresses this need.

### BRIEF DESCRIPTION OF THE DRAWINGS

To facilitate understanding, identical reference numerals have been used, where possible, to designate identical elements that are common to the drawings. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an exemplary illustration of a novel system including a robotic device consistent with the present disclosure.

FIG. 2 is a flowchart for a method of reconfiguring a behavior image within a robotic device.

FIG. 3 is a flowchart for a method of selecting a customized behavior image.

FIG. 4 is a flowchart of a method for receiving and employing a customized behavior image for use within a robotic device.

FIG. 5 is an exemplary illustration of a robotic device within an object environment.

FIG. 6 is a table listing the rank for each object within the robotic device's object environment.

FIG. 7 is a table listing codes for unique behavior images.

FIG. 8 is a table listing outputs for two exemplary behavior images.

### DETAILED DESCRIPTION OF THE PRESENT DISCLOSURE

A detailed description of some embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

A system described herein pertains to robotic devices, and in particular to robotic devices with a unique output profile. A system consistent with the present disclosure includes an apparatus which includes a set of input devices, a set of output devices, and a memory unit. The memory unit includes a behavior image which dictates the manner in which the at least one output device operates. Receiving data through at least one of the input devices over a first time period reconfigures the behavior image.

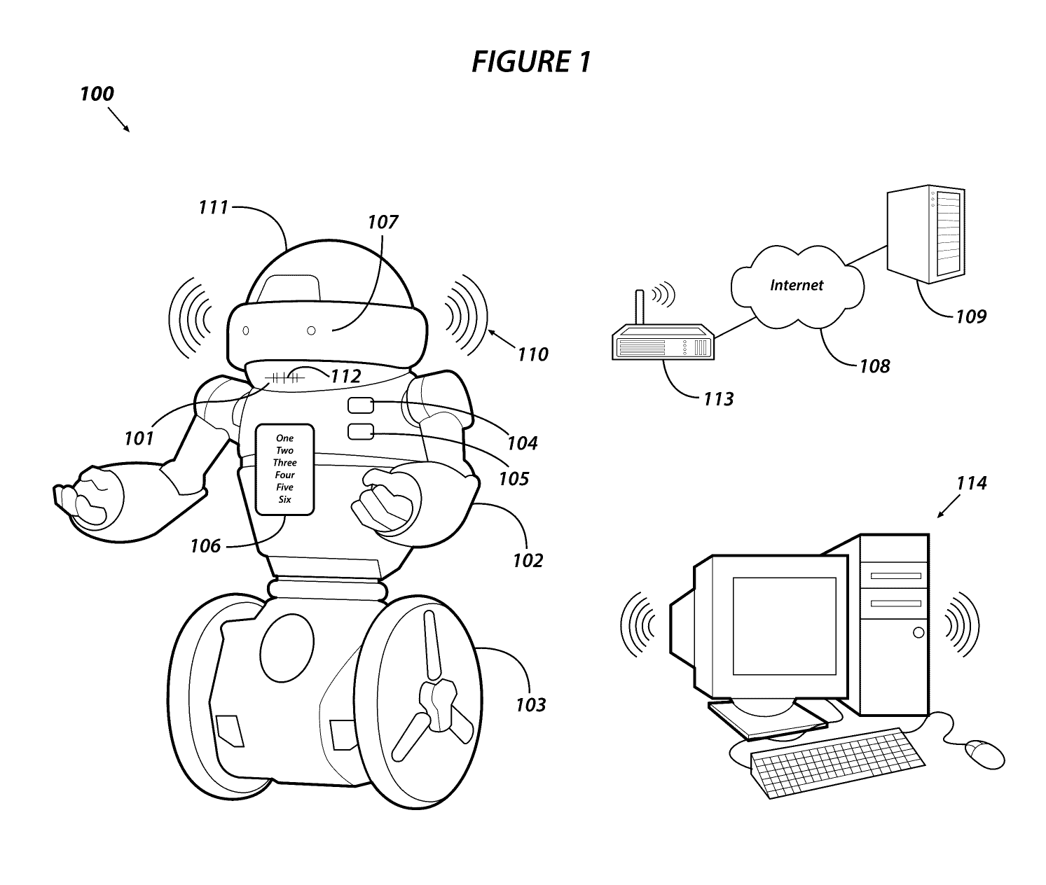

FIG. 1 is an exemplary illustration of a novel system including a robotic device 100 consistent with the present disclosure. Robotic device 100 may include various components which function to give the device 100 its own uniqueness. In the embodiment shown, robotic device 100 includes a head portion 111 which includes electronic circuitry such as, but not limited to, a processor, memory, components for wireless communication, and other conventional electronic components and devices known in the art that controls the device 100. Head portion 111 includes a first set of light emitting diodes 101 (LEDs) that resembles a human mouth and also includes a second set of LEDs 107 that resemble human eyes. In addition, head portion 111 includes a speaker device 112 within the perimeter of LEDs 107.

Most notably, robotic device 100 includes a memory unit (not shown) which includes a behavior image which may include default settings. A behavior image includes computer instructions for a manner in which at least one output device of the robotic device 100 operates. As such, the behavior image includes computer instructions for the robotic device 100 to employ a unique output.

Robotic device 100 includes a set of input devices 104, 105. The input devices may include sensory devices. For example, input devices may include an auditory sensing device, temperature sensing device, infrared sensing device, proximity sensing device, and an attention sensing device. In addition, robotic device 100 includes a set of output devices. It should be understood by one having ordinary skill in the art that display unit 106 may also be an input device such that an operator may input instructions for the robotic device 100 to carry out.

Robotic device 100 may employ the aforementioned sensing devices (e.g., auditory sensing device) to locate the distance that the device 100 is from other objects within its object environment. For example, robotic device 100 may have an auditory sensor on one side of head portion 111 and another auditory sensor on the other side such that the difference in the detection of the auditory signals can be used to employ positional triangulation.

The output devices of robotic device 100 include a set of light emitting diodes 101, 107, a set of end effectors 102, a display unit 106, and speaker 112. Most notably, the behavior image within the memory unit may control the manner in which the set of light emitting diodes 101, 107 or other output devices operation. End effectors 102 and wheels 103 enable the device to perform tasks, move around, and entertain.

A display unit 106 may be disposed on a surface of robotic device 100. Display unit 106 may display text, images, videos, or other visual content. The content displayed on display unit 106 may be preprogrammed within the display unit 106 or may be retrieved from an external source. For example, robotic device 100 may have wireless capability 110 to connect with the Internet 108 (via router 113) to access content from an external server 109. As will be explained in more detail below, robotic device 100 may retrieve a behavior image data from external server 109 in this manner.

Robotic device 100 may have more or less components and devices than those shown in the figure. As such, the present disclosure is not limited to a robotic device 100 which includes the components and devices shown and described. Robotic device 100 may further include a power unit (not shown) to receive power from an external power source. Robotic device 100 may also include an internal power unit.

FIG. 1 also shows a computer system 114 that may be accessed by an operator of the robotic device 100. Computer system 114 may also have wireless capability via router 113 to access external server 109. In addition, an operator may control robotic device 100 directly via a software application loaded onto computer system 114 and may determine which behavior image the device 100 employs.

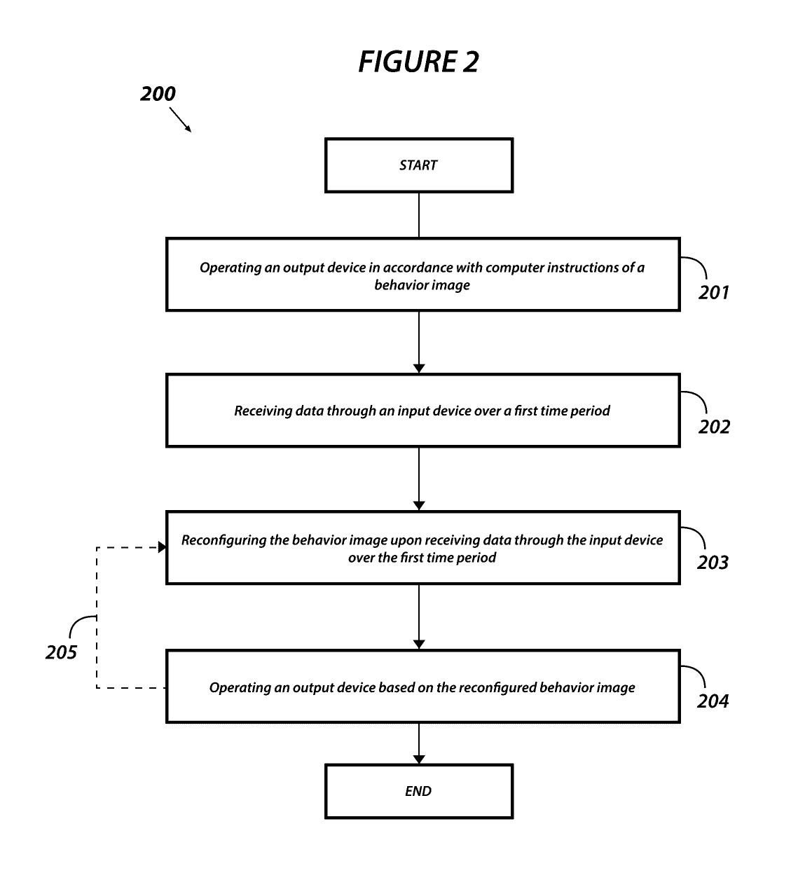

FIG. 2 is a flowchart 200 for a method of reconfiguring a behavior image within a robotic device. Flowchart 200 begins with block 201—operating an output device in accordance with computer instructions of a behavior image.

For example, the two sets of LEDs on the head portion of the robotic device may have a specific disposition which resembles a human expression (e.g., happy, mad, or sad). Alternatively, the robotic device may output a voice signal which has a pitch, tone, and decibel level that closely matches that of an object in the device's object environment.

In the present disclosure, an object may be defined as a person on another robotic device within the object environment. An object environment may be defined as the physical space in which other persons (e.g., family members) or robotic devices regularly cohabitate. In some embodiments, an object environment may be a home, office, or other confined physical space in which objects regularly interact.

Next, receiving data through an input device over a first time period (block 202). As previously described, the input device may be a sensory device that detects speech, heat, or object proximity. In addition, the data retrieved from one or more input devices may also give an indication about other object activity. For example, voice signal and proximity data may indicate the attention that objects within the object environment are giving other objects.

Next, reconfiguring the behavior image upon receiving data through the input device over the first time period (block 203). Accordingly, in some embodiments of the present disclosure, the behavior image within the robotic device's memory unit may be reconfigured after a predetermined time period.

For instance, the robotic device may utilize its auditory sensing device to record the pitch, tone, and decibel level of detected voice signals over a predetermined time period. As such, the robotic device may output an audible communication that has an average pitch, tone, and decibel level detected over the predetermined time period.

The predetermined time period may be any set time period. For example, the predetermined time period may be 30 days, 60 days, or 90 days. The predetermined time period may be configurable such that it may change. For example, an operator may input a new time period via the robot device's display unit.

Next, operating an output device based on the reconfigured behavior image (block 204). Accordingly, the robotic device will operate according to the new settings provided by the reconfigured behavior image.

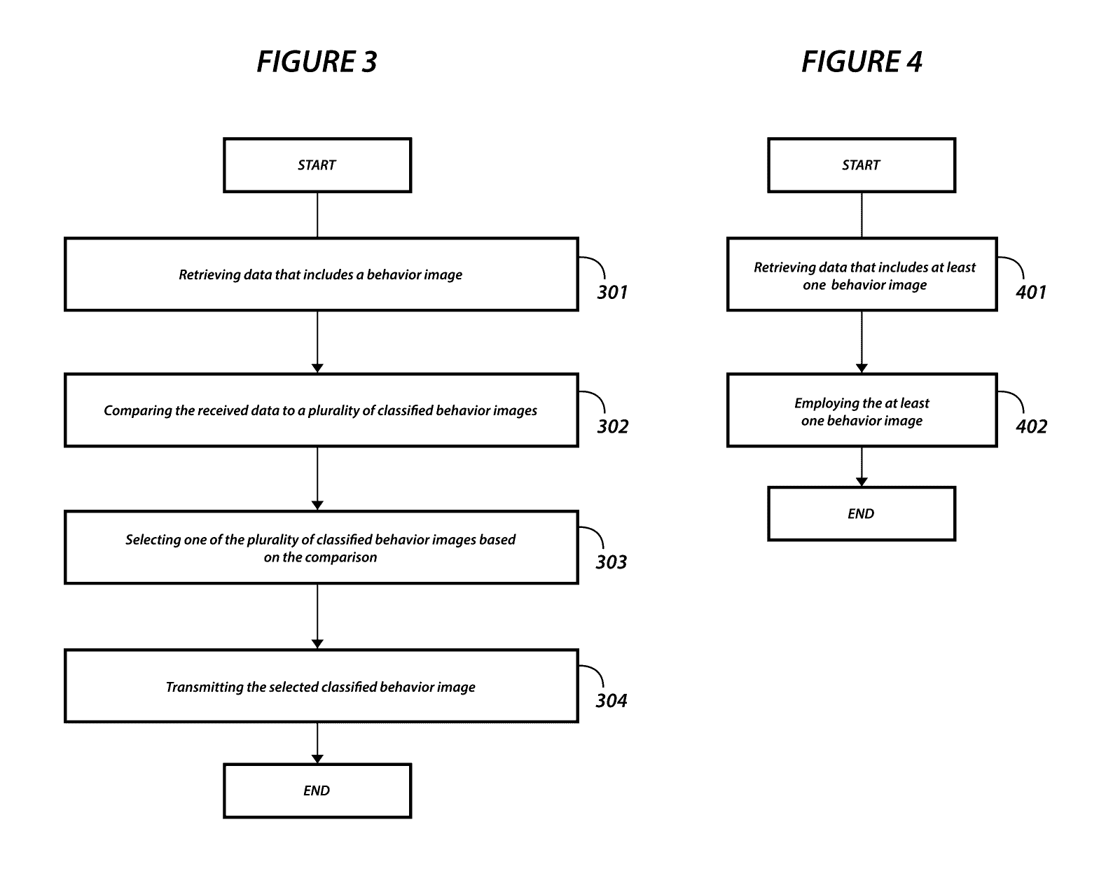

FIG. 3 is a flowchart 300 for a method of selecting a customized behavior image for use within a robotic device. Flowchart 300 begins with block 301—retrieving data that includes a behavior image. In some embodiments, the data may be retrieved at a network server that is in wireless communication with the robotic device.

Block 302—comparing the received data to a plurality of customized behavior images. A network server may have a plurality of customized behavior images as will be described further below.

Based on the comparison, selecting one of the plurality of customized behavior images (block 303). The selected customized behavior image may be similar to the received behavior image. For example, if the received behavior image indicates that the robotic device's object environment includes a particular family profile (e.g., a single parent and two children), the selected customized behavior image may be customized and take into account that family profile which has been successfully deployed by robotic devices in other object environments. Alternatively, the selected customized behavior image may be substantially different than the behavior image received.

Block 304—transmitting the selected customized behavior image. In some embodiments, the selected customized behavior image is transmitted directly to the robotic device. In other embodiments, behavior images may be the stored within the robotic device's memory unit and one of which may be selected by an operation via the device's display unit.

FIG. 4 is a flowchart 400 for a method of receiving and employing a customized behavior image for use within a robotic device. Flowchart 400 begins with block 401—retrieving data that includes at least one behavior image. The robotic device may directly retrieve the at least one behavior image from a network server. Next, employing the at least one behavior image (block 402). As such, the robotic device will operate according to the new behavior image received.

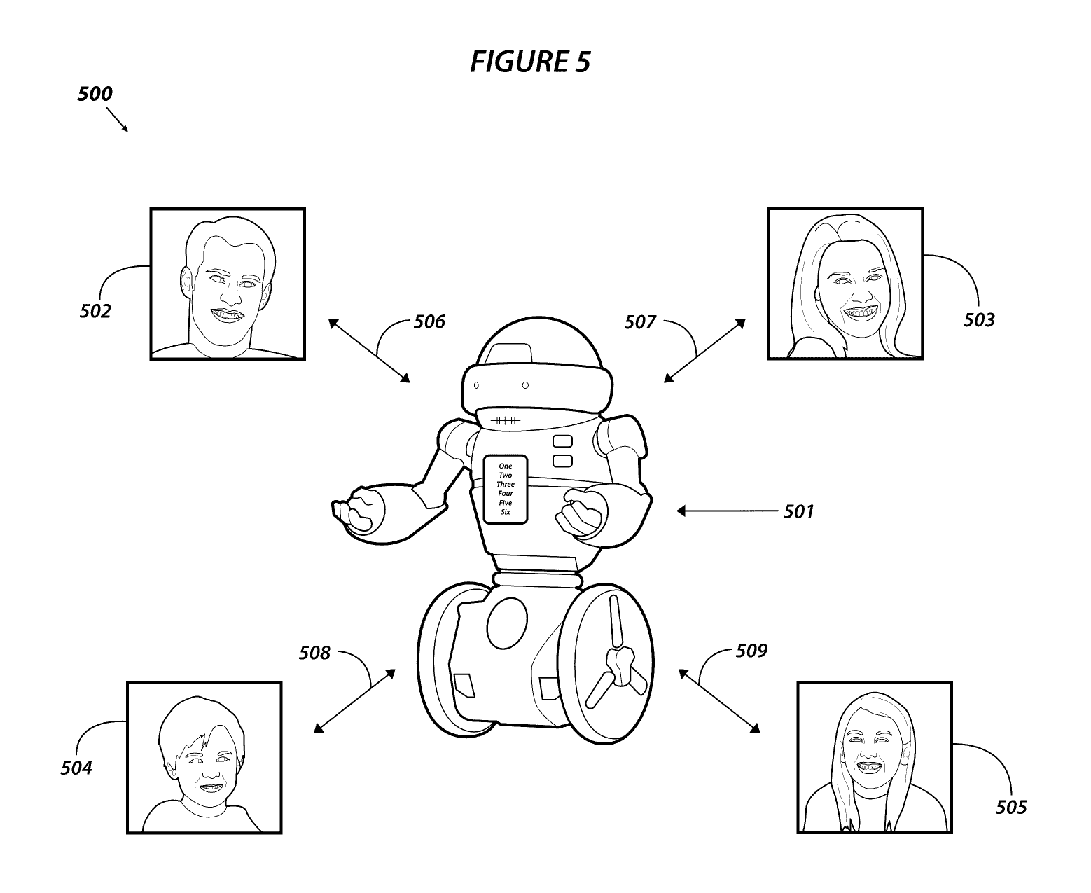

FIG. 5 is an exemplary illustration of a robotic device 501 within an object environment 500. As shown, within object environment 500 is a first parental FIG. 502, a second parental FIG. 503, a first child FIG. 504, and a second child FIG. 505. In some embodiments, robotic device 501 has a unique attachment with each object within its object environment 500.

For example, the attachment that robotic device 501 has with the first parental FIG. 502 is represented by attachment 506. Likewise, robotic device 501 has an attachment 507 with second parental FIG. 503, an attachment 508 with first child FIG. 504, and an attachment 509 with second child FIG. 505. In some implementations, the robotic device's behavior image may dictate that the device's output varies based upon the object that the device is communicating with.

Therefore, the robotic device may exhibit a unique output according to which object that the robotic device is relating to. For instance, when relating to the first parental FIG. 502, the audible output may be low pitch and at approximately 85 decibels. Alternatively, when relating to the second parental FIG. 503, the audible output may be high pitch and at approximately 75 decibels.

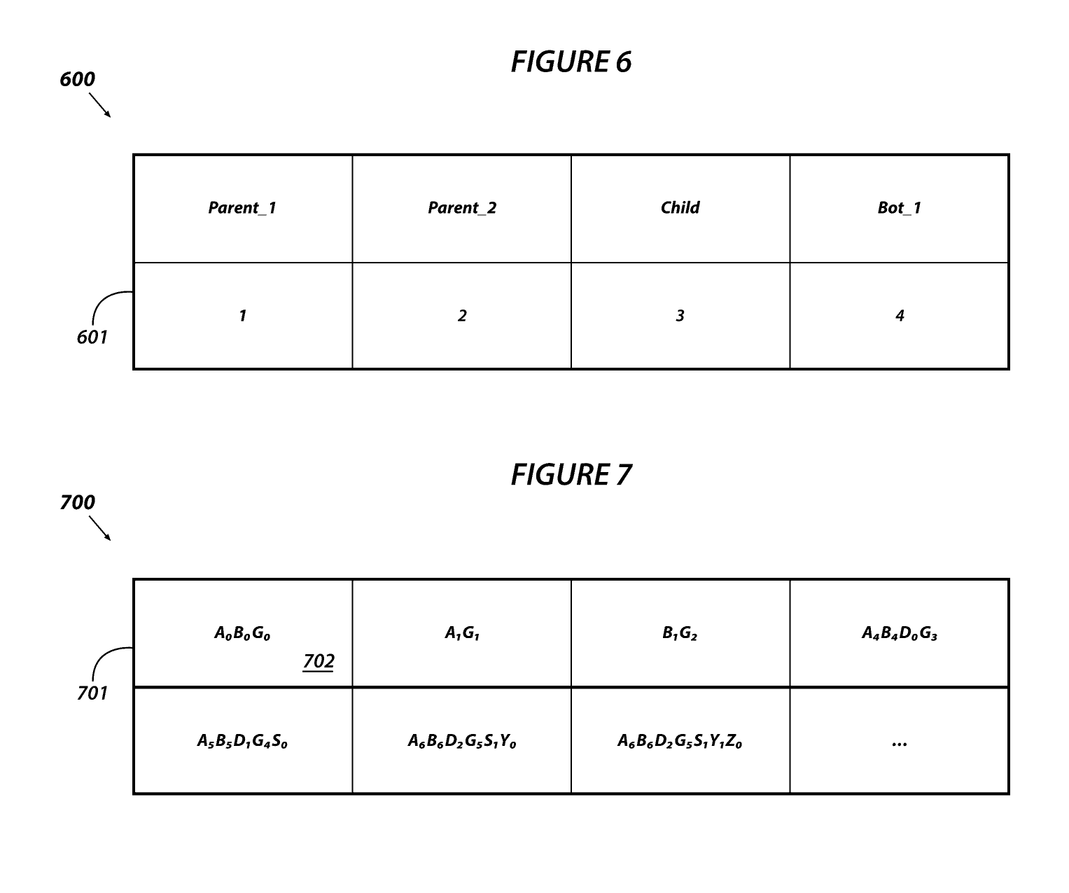

FIG. 6 is a table 600 listing the rank for each object within the robotic device's environment. Table 600 includes cells 601 with a ranking of each object within the robotic device's object environment. In the example shown, Parent_1 is ranked first, Parent_2 is ranked second, Child is ranked third, and Bot_1 (another robotic device) is ranked fourth. As such, when the robotic device is amongst any two objects at one time, the device will relate to the other objects in the manner that it would relate to the highest ranked object (i.e., Parent_1) that is in the device's presence. It should be understood by one having ordinary skill in the art that cells 601 are representative of memory cells within a memory unit.

FIG. 7 is a table 700 listing codes for unique behavior images. In particular, within each cell 701 is a unique behavior image code which dictates the output of a robotic device. Cell 702, for example, contains A₀B₀G₀. Behavior image code A₀B₀G₀ may include output settings for a primary-rank parent (A₀), a secondary-rank parent (B₀), and a constant value (G₀). It should be understood by one having ordinary skill in the art that constant value G₀ is optional and may not be incorporated into a behavior image as described herein.

The unique behavior image codes may include various other default output settings. For example, the behavior image codes may include default output settings for a primary-rank child (D), second-rank child (S), another robotic device (Z), and other components.

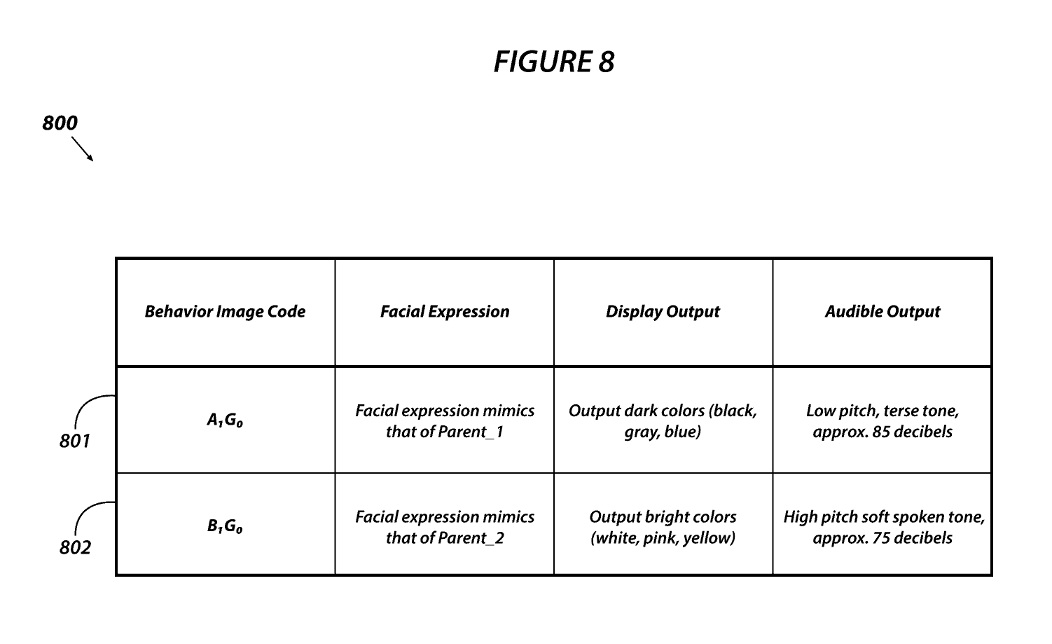

FIG. 8 is a table 800 listing output settings within two exemplary behavior image codes (within cells 801, 802). As shown, the outputs associated with each behavior image code are listed in the subsequent rows. The behavior image code listed within cell 801 is A₁G₀. For this image code, the facial expression, display, and audible output settings are shown. Likewise, those output settings for behavior image code B₁G₀ are also shown in table 800. It should be understood by one having ordinary skill in the art that the information shown in table 800 is stored within the robotic device's memory unit.

The preceding Description and accompanying Drawings describe examples of embodiments in some detail to aid understanding. However, the scope of protection may also include equivalents, permutations, and combinations that are not explicitly described herein. Only the claims appended here (along with those of parent, child, or divisional patents, if any) define the limits of the protected intellectual-property rights.

What is claimed is:

1. An apparatus, comprising:
at least one input devices;
at least one output device; and
a memory unit;
the memory unit includes a behavior image, wherein the behavior image dictates the manner in which the at least one output device operates;
wherein upon receiving data through the at least one input device over a first time period reconfigures the behavior image.

2. The apparatus of claim 1, wherein the at least one input device includes a set of sensory device wherein the set of sensory devices includes an auditory sensing device, temperature sensing device, and an attention sensing device.

3. The apparatus of claim 1, wherein the at least one output device is a display unit, speaker, or light emitting diode.

4. The apparatus of claim 1, wherein the memory unit includes customized behavior images.

5. The apparatus of claim 1, wherein the memory unit includes default settings for the behavior image.

6. The apparatus of claim 5, wherein the behavior image includes computer instructions for a manner in which the at least one output device operates.

7. The apparatus of claim 6, wherein the behavior image includes computer instructions for the apparatus to employ a unique output.

8. The apparatus of claim 1 further comprising a set of light emitting diodes which mimic a facial disposition when engaged.

9. The apparatus of claim 8, wherein the behavior image includes computer instructions which dictate which light emitting diode to engage to mimic the facial disposition.

10. The apparatus of claim 1 further comprising electronic circuitry wireless communication capability.

11. The apparatus of claim 10, wherein data which includes a behavior image may be retrieved via the wireless communication capability.

12. A system, comprising:
a first robotic device, comprising:
a set of input devices;
a set of output devices;
a memory unit;
the memory unit includes a behavior image, wherein the behavior image includes computer instructions for a manner in which the at least one output device operates;
wherein upon receiving data through the at least one of the input devices over a first time period reconfigures the behavior image; and
electronic circuitry to effect wireless communication; and
a network server, comprising:
a database which includes memory which stores a plurality of customized behavior images.

13. The system of claim 12, wherein the first time period is at least 30 days.

14. The system of claim 12, wherein the first robotic device has at least one human attribute.

15. The system of claim 12, wherein the first robotic device includes a power unit to receive power from an external power source.

16. The system of claim 12 further comprising a second robotic device wherein each robotic device has the same set of input devices, output devices, and memory unit.

17. A method, comprising:
operating an output device in accordance with a first behavior image;
wherein the first behavior image includes computer instructions for a manner in which the output device operates;
utilizing an input device to retrieve data over a first time period; and
reconfiguring the first behavior image as a result of retrieving the data.

18. The method of claim 18 further comprising operating an output device based on the reconfigured behavior image.

19. The method of claim 17, wherein the received data is from at least one object within a controlled environment.

20. The method of claim 17, wherein the reconfigured behavior image includes a portion of the settings of the first behavior image.
